(19) United States
(12) Patent Application Publication
(10) Pub. No.: US 2010/0185971 A1
(43) Pub. Date: Jul. 22, 2010

(54) MOBILE TERMINAL DEVICE AND INPUT DEVICE

(75) Inventor: Masahiro Ito, Tokyo (JP)

Correspondence Address: Schwabe Williamson & Wyatt;PACWEST CENTER, SUITE 1900, 1211 SW FIFTH AVENUE, PORTLAND, OR, 97204, US

(73) Assignee: YAPPA CORPORATION, Tokyo (JP)

(21) Appl. No.: 12/664,612

(22) PCT Filed: Jun. 13, 2007
(86) PCT No.: PCT/JP2007/000627

§ 371 Date: Dec. 14, 2009

(51) Int. Cl. G06F 3/048

(52) U.S. Cl. 715/773

(57) ABSTRACT

A mobile terminal device according to the present invention includes: an area setting unit, a software key display unit, a pointing device and a character information display unit. The area setting unit sets a plurality of display areas for displaying a plurality of software keys mapped to each of a plurality of pieces of character information included in a predetermined input character type. The software key display unit displays the two or more software keys assigned to each of the plurality of display areas set up by the area setting unit, in corresponding display areas. The plurality of pointing devices select the software keys displayed by the software key display unit, independently for every display area in accordance with an operation made by a user. The character information display unit displays character information corresponding to the software key selected by the pointing device.

### FIELD OF THE INVENTION

The present invention relates to an input device, and in particular, to a mobile terminal device and an input device provided with a pointing device.

### BACKGROUND ART

Recently, miniaturization of mobile terminal devices have been developing. However, with the progress of the miniaturization, an area where operation keys can be arranged becomes smaller. Thereby, the number of the operation keys that can be arranged is decreased, resulting in a poor input environment. To deal with such a problem, techniques of operating a plurality of software keys displayed on a screen with a pointing device, have been conventionally disclosed (see, for example, Patent Documents 1 and 2).

[Patent Document 1] Japanese Patent Application Publication No. 2005-323236

[Patent Document 2] Japanese Patent Application Publication No. 2002-006988

### DISCLOSURE OF THE INVENTION

### Problem to be Solved by the Invention

A user selects character information mapped to a desired software key by operating a pointing device to move a pointer displayed on a screen onto the desired software key. Herein, in the case where the software keys, each of which is mapped to each character string to be inputted, are displayed at positions apart from each other, or the case where an amount of characters to be inputted is large, an operation amount of the pointing device is increased, taking a time to input the characters. Even in these cases, however, it is preferable that input operations can be performed efficiently.

The present invention has been made in view of such a situation, and a general purpose of the invention is to provide an input environment in which input operations can be performed efficiently.

### Means for Solving the Problem

In order to solve the aforementioned problem, a mobile terminal device according to an embodiment of the present invention comprises: an area setting unit configured to set a plurality of display areas for displaying a plurality of software keys mapped to each of a plurality of pieces of character information included in a predetermined input character type; a software key display unit configured to display two or more software keys assigned to each of the plurality of display areas set by the area setting unit, in corresponding display areas; a plurality of pointing devices configured to be able to select the software keys displayed by the software key display unit, independently for every display area; and a character information display unit configured to display character information corresponding to the software key selected by the pointing device.

Herein, the input character types may include a plurality of pieces of character information that can be inputted, or may be an arrangement of character information, for example, the QWERTY arrangement representing the alphabetical order used in the English-speaking world. Further, the character information includes alphanumeric characters, kava characters, operators such as “+” and “=”, or symbols such as “?” and “(”. The software keys are operation keys to be assigned various functions such as display of a character and calculation, including an operation key displayed on a screen. For example, when the software key mapped to the alphabetical character “A” is selected, “A” is displayed on the screen. The pointing device maybe an arrow key, stick key, trackball, or trackpad. By a user operating the pointing device, a pointer displayed on the screen is moved, or the software key indicated by the pointer is selected. By operating the pointer displayed in an assigned area with the pointing device, a user can select the software key displayed in the area.

According to the embodiment, input operations can be performed efficiently by using a plurality of pointing devices to independently select each software key displayed for every display area.

The plurality of pointing devices may include a left-hand pointing device and a right-hand pointing device, which are arranged to be a right-and-left pair in front of the screen of the mobile terminal device. In this case, input operations can be performed efficiently by operating each of the pointing devices with each hand.

Each of the plurality of display areas set by the area setting unit may be mapped to each of the plurality of pointing devices. The pointing device may select the software key specified for every display area by moving the pointer displayed in the display area thus mapped. A moving range of the pointer operated by the single pointing device can be limited by dispersing a plurality of software keys to display the keys in every display area, as stated above. Thereby, input operations can be performed efficiently, allowing an input speed to be improved.

All character information included in the predetermined input character type may be mapped to any one of the plurality of software keys displayed by the software key display unit. In this case, by displaying all character information in any one of the areas as a software key, an operation range of the pointing device can be limited allowing input operations to be performed efficiently.

Any one of the plurality of pieces of character information included in the predetermined input character type, may be duplicatively mapped to a plurality of software keys so as to be displayed in two or more display areas. In this case, more intuitive operations can be performed by mapping a software key having a high frequency of use to a plurality of areas, allowing input operations to be performed efficiently.

The predetermined character type may be alphabet. The plurality of pointing devices may include a left-hand pointing device and a right-hand pointing device. The area setting unit may set two display area, each of which is mapped to each of the left-hand and the right-hand pointing devices. The software key display unit may display, among the QWERTY arrangement representing the alphabet order, at least the software keys corresponding to each of the character information of “Q”, “W”, “E”, “R”, “A”, “S”, “D”, “F”, “Z”, “X”, “C” and “V”, in the display area corresponding to the left-hand pointing device; on the other hand, display, among the QWERTY arrangement, at least the software keys corresponding to each of the character information of “U” “I”, “O”, “P”, “J”, “K”, “L” and “M”, in the display area corresponding to the right-hand pointing device.

By dispersing the plurality of software keys to display the keys in the two divided display areas as stated above, a moving range of the pointer operated by the single pointing device can be limited. Thereby, input operations can be performed efficiently, allowing an input speed to be improved. For a user who has mastered blind touch, intuitive input operations using the two pointing devices can be performed by arranging characters to be inputted with each of right hand and left hand in a dispersed manner, allowing a comfortable input environment to be realized.

The software key display unit may duplicatively display, among a plurality of pieces of character information included in the QWERTY arrangement, at least the software keys corresponding to each of the character information of “Y”, “T” and “B”, in both display areas corresponding to each of the left-hand pointing device and the right-hand pointing device. In this case, more intuitive input operations can be performed by mapping, among the QWERTY arrangement, the keys operable with each of left fingers and right fingers, to the plurality of display areas, thereby allowing input operations to be performed efficiently.

The mobile terminal device may further comprise a hardware key having a function of inputting any one of a conversion process, backspace processing and a space character. In this case, input operations can be performed more efficiently by assigning the functions such as a conversion process, backspace processing or input of a space character, which have high frequencies of use, to the hardware keys.

The hardware key may be arranged so as to be operated with a finger different from that operating the software key. In this case, input operations cans be performed more efficiently by operating the software key with a thumb and the hardware key with an index finger.

Another embodiment of the present invention relates to an input device. The device comprises: a software key display unit configured to display a plurality of software keys, each of which is mapped to character information included in a predetermined input character type, in each of two display areas in accordance with a character arrangement; two pointing devices configured to select each of the software keys displayed by the software key display unit, independently for every display area; and a character information display unit configured to display the character information corresponding to the software key selected by the pointing device. The software key display unit may specify the correspondence relationship between a text character and an area in accordance with a user's typing way. According to such an embodiment, input operations can be performed efficiently.

It is noted that any combination of the aforementioned components or any manifestation of the present invention exchanged between methods, devices, systems and recording media, computer programs and so forth, is effective as an embodiment of the present invention.

### Advantage of the Invention

According to the present invention, an input environment in which high-speed input operations are performed can be realized.

### BRIEF DESCRIPTION OF THE DRAWINGS

FIG. 1 in a view illustrating a structure example of a mobile terminal device according to an embodiment of the present invention;

FIG. 2 is a view illustrating a display example of on the display screen in FIG. 1;

FIG. 3 is a view illustrating a structure example of a function block included in the mobile terminal device in FIG. 1;

FIG. 4 is a view illustrating a first variation of the structure example of the mobile terminal device in FIG. 1;

FIG. 5 is a view illustrating a second variation of the structure example of the mobile terminal device in FIG. 1;

FIG. 6 is a view illustrating a third variation of the structure example of the mobile terminal device in FIG. 1;

FIG. 7 is a view illustrating a fourth variation of the structure example of the mobile terminal device in FIG. 1;

FIG. 8 is a view illustrating a first variation of a pointing device in FIG. 1;

FIG. 9 is a view illustrating a second variation of the pointing device in FIG. 1;

FIGS. 10A and 10B are views illustrating a third variation of the pointing device in FIG. 1;

FIG. 11 is a view illustrating a first variation of the display example on the display screen in FIG. 2;

FIG. 12 is a view illustrating a second variation of the display example on the display screen in FIG. 2;

FIG. 13 is a view illustrating a third variation of the display example on the display screen in FIG. 2; and

FIG. 14 is a view illustrating a fourth variation of the display example on the display screen in FIG. 2.

### REFERENCE NUMERALS

10 POINTING DEVICE
12 DIRECTION KEY
14 DETERMINATION KEY
16 ROTATION KEY
18 TRIANGULAR ARROW
20 HARDWARE KEY
30 DISPLAY SCREEN
32 DETERMINED CHARACTER DISPLAY COLUMN
34 SOFTWARE KEY DISPLAY COLUMN
36 SOFTWARE KEY
38 POINTER
50 SOFTWARE KEY RECEIVING UNIT
52 HARDWARE KEY RECEIVING UNIT
54 DISPLAY CONTROL UNIT
56 DISPLAY UNIT
58 POINTING DISPLAY PROCESSOR
60 ANALYSIS UNIT
62 SOFTWARE KEY DISPLAY PROCESSOR
64 AREA SETTING UNIT
66 FUNCTION PROCESSOR
100 MOBILE TERMINAL DEVICE
110 HOUSING

### DETAILED DESCRIPTION OF THE INVENTION

Before describing an embodiment of the present invention in detail, the outline thereof will be described at first. An embodiment of the present invention relates to an input method for a mobile terminal device. In general, input methods for mobile terminal devices include a method of using hardware keys and that of using software keys.

In the method of using hardware keys, operation keys are installed in a mobile terminal device as hardware, and a user presses down an operation key to input an alphanumeric character, kana character, operator such as “+” or “−”, or symbol such as “@” or “?” (hereinafter, collectively referred to as “character information”), which is assigned to every operation key. On the other hand, in the method of using software keys, a plurality of operation keys are at first displayed on the screen as software keys. Herein, a user moves a pointer displayed on the screen to approach a software key assigned the character information to be inputted. And then by executing processing of selecting a desired software key while the pointer is indicating the software key, the character information assigned to the software key is inputted. Processing of moving the pointer or selecting the software key can be realized by a user operating a pointing device such as a trackpad.

The number of the hardware keys that can be arranged is limited due to a space size where the hardware keys can be installed. Especially in the case of a small mobile terminal device, the restriction becomes significant. Further, the screen is needed to be small if many hardware keys are installed, and hence the number of the keys is mostly limited to a minimal number. Accordingly, a single hardware key is mostly assigned a plurality of functions. For example, a hardware key is assigned alphabetical characters “A”, “B” and “C” such that a character to be displayed is switched by the number of the hardware key pressed down. However, if a hardware key is assigned a large number of functions, an input operation becomes complicated and an input speed becomes slow.

The software keys are not restricted by the arrangement space; however, the operation with the use of the pointing device is likely to be complicated. For example, a software key group in the QWERTY arrangement is usually displayed in an integrated manner and in a horizontally long shape, and hence an operation of moving the pointer takes a time. A user who had mastered blind touch to the QWERTY arrangement usually remembers the characters operated with each of left hand and right hand. However, even if the software key group in the QWERTY arrangement is displayed on the screen, the user cannot exert his/her blind touch capability by operating the single pointing device.

From the aforementioned situations, in the present embodiment, a plurality of pointing devices used for selecting software keys displayed on the screen are prepared to enable an operation of moving the pointer to be performed easily, allowing an efficient input environment to be realized. According to such an embodiment, a user having high blind touch capability can perform input operations more comfortably.

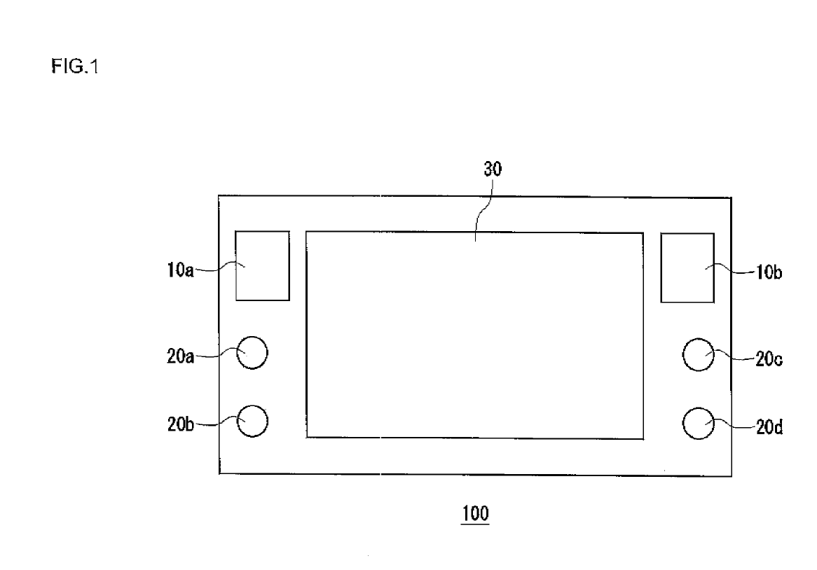

FIG. 1 is a view illustrating a structure example of a mobile terminal device 100 according to an embodiment of the present invention. The mobile terminal device 100 includes: a first pointing device 10a and a second pointing device 10b, represented by a pointing device 10; a first hardware key 20a through a fourth hardware key 20d, represented by a hardware key 20; and a display screen 30. The mobile terminal device 100 is a portable small terminal device including, for example, a cell phone, PDA (Personal Digital Assistant) or digital camera, etc. Hereinafter, descriptions with respect to a communication function of the cell phone or an imaging function of the digital camera, will be omitted for convenience of description.

The pointing device 10 is composed of a trackpad, etc. The pointing device 10 executes an operation of moving a pointer displayed on the screen 30, and executes processing of selecting a software key indicated by the pointer, by operations of a user. By operating the pointing device 10 with a finger, the user executes an operation of moving the pointer displayed on the screen 30. Further, by pressing down the pointing device 10, the user executes the selection processing. Herein, the first pointing device 10a can be operated with left hand, and the second pointing device 10b with right hand. Accordingly, the two pointing devices 10 can be operated independently of each other. Thereby, the user can improve an input speed by operating the two pointing devices 10 independently of each other.

A function assigned to every hardware key 20 is executed by pressing down the key 20. The functions to be assigned have high frequencies of use, including, for example, a power ON/OFF function, input mode selection function and camera shutter function, etc. When the hardware key 20 assigned the input mode selection function is pressed down, a software input mode is executed in which a plurality of software keys are displayed on the display screen 30. The hardware keys 20 may be assigned functions such as a space key, conversion key, and backspace key. The first hardware key 20a and the second hardware key 20b are operated with left hand, whereas the third hardware key 20c and the fourth hardware key 20d with right hand.

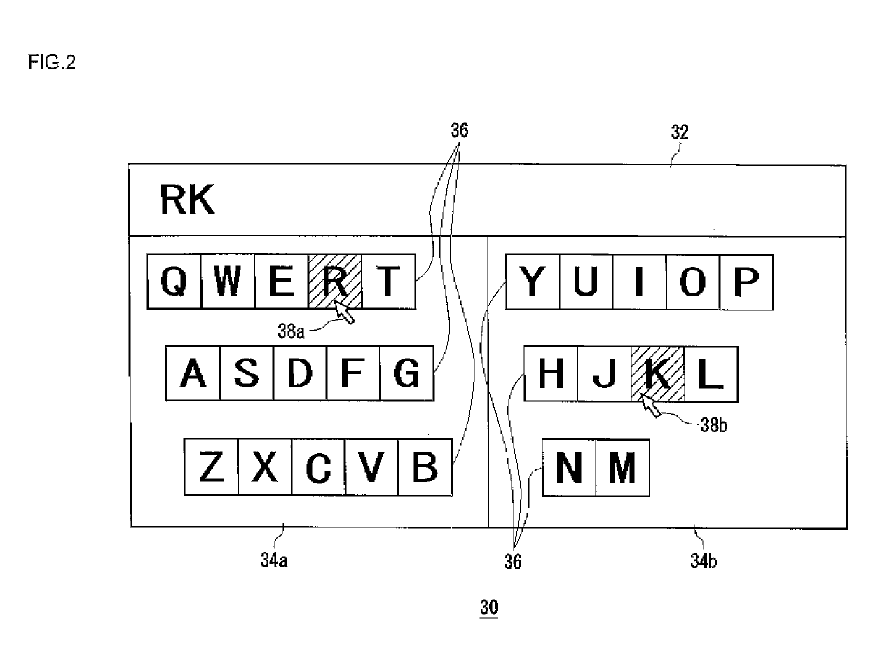

FIG. 2 is a view illustrating a display example on the display screen 30 in FIG. 1. FIG. 2 illustrates a display example when the software input mode is executed. The display screen 30 includes: a determined character display column 32; and a first software key display column 34a and a second software key display column 34b, represented by a software key display column 34. A plurality of software keys 36 and pointers 38 are displayed in the software key display column 34.

A first pointer 38a is displayed in the first software key display column 34a. The first pointer 38a is a pointer cursor that can be moved by operating, with left hand, the first pointing device 10a in FIG. 1. Likewise, a second pointer 38b operable with a second pointing device 10b for right hand is displayed in the second software key display column 34b.

As illustrated in the drawing, the plurality of software keys 36 are displayed in the software key display column 34 as respectively corresponding character information. Herein, the character information based on the QWERTY arrangement correspond to each of the plurality of software keys 36. For convenience of description, the software keys 36 corresponding to numbers, operators such as “+” and “−”, and symbols such as “[” and “?”, are omitted in the drawing.

Herein, among the QWERTY arrangement, a plurality of pieces of character information to be pressed down with left hand are assigned to the first software key display column 34a and displayed there as the software keys 36. The character information to be pressed down with left hand refer to character information to be pressed down with left hand in the case of the hardware keys. Specifically, as illustrated in the first software key display column 34a in FIG. 2, the column 34a being an area corresponding to the first pointing device 10a for left hand, the character information refer to an alphabet group including, among the QWERTY arrangement, at least “Q”, “W”, “R”, “A”, “S”, “D”, “F”, “Z”, “X”, “C” and “V”.

On the other hand, among the QWERTY arrangement, character information to be pressed down with right hand are assigned to the second software key display column 34b such that the character information are not duplicative with those displayed in the first software key display column 34a, and displayed there as the software keys 36. As illustrated in the second software key display column 34b in FIG. 2, the column 34b being an area corresponding to the second pointing device 10b for right hand, the character information to be pressed down with right hand refer to an alphabet group including, among the QWERTY arrangement, at least “U”, “I”, “O”, “P”, “J”, “K”, “L” and “M”.

In FIG. 2, the first pointer 38a points at “R” among the software keys 36, whereas the second pointer 38b “K”. Herein, “R” and “K” at which the pointer 38 points are displayed in emphasized manners as illustrated. The emphasized manner is not limited to that thus illustrated, but the objective character or software key 36 may be made larger in size than other characters or other software keys 36, or the objective character may be colored by a color different from those of other characters.

Under the aforementioned circumstances, by a user pressing down the pointing device 10, the software key 36 at which the corresponding pointer points is selected, allowing the character information assigned to the software key 36 to be displayed in the determined character display column 32. Herein, the first pointing device 10a is at first operated with left hand to execute the processing of selecting “R”. Subsequently, the second pointing device 10b is operated with right hand to execute the processing of selecting “K”. In such a case, “RK” is displayed in the determined character display column 32 as illustrated.

As stated above, a moving range of the pointer 38 operated by the single pointing device 10 can be limited by dividing the plurality of software keys 36 into two groups, each of which is displayed in one of the two software key display columns 34. Thereby, input operations can be performed efficiently, allowing an input speed to be improved. Further, for the user who has mastered blind touch, intuitive input operations can be performed by arranging, in a dispersed manner, characters to be inputted with each of left hand and right hand in the two software key display columns 34, allowing a comfortable input environment to be realized.

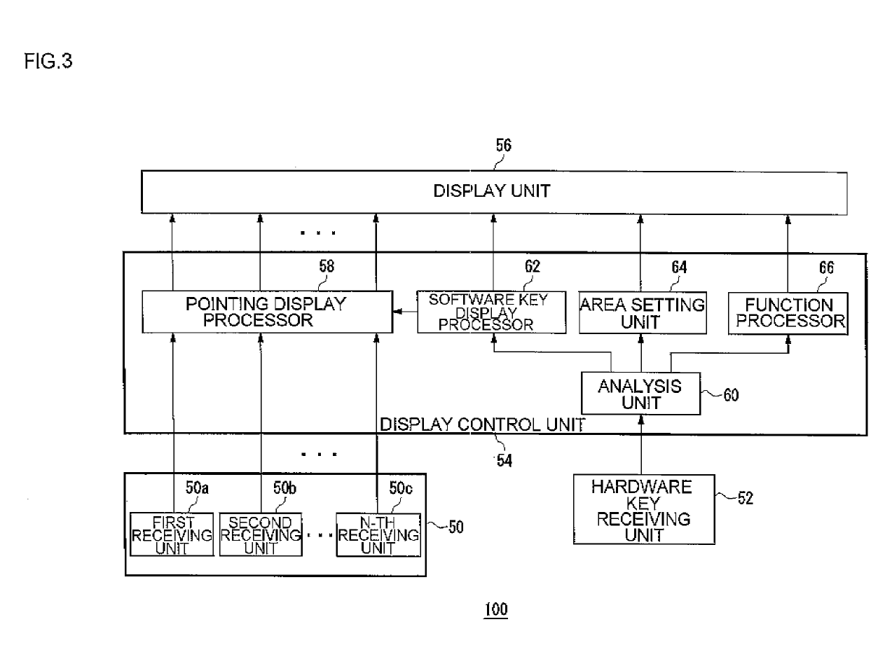

FIG. 3 is a view illustrating a structure example of a function block included in the mobile terminal device 100 in FIG. 1. The mobile terminal device 100 includes a software key receiving unit 50, a hardware key receiving unit 52, a display control unit 54 and a display unit 56.

The hardware key receiving unit 52 receives an operation executed by a user to the hardware key 20 in FIG. 1. The hardware key receiving unit 52 determines the hardware key 20 thus operated and communicates to the display control unit 54 that the hardware key 20 has been operated. Herein, it is assumed that each of the plurality of hardware keys 20 is assigned the power ON/OFF function, a function of executing a software input mode, or the camera shutter function, etc.

The display control unit 54 includes a pointing display processor 58, an analysis unit 60, a software key display processor 62, an area setting unit 64 and a function processor 66.

The analysis unit 60 analyzes which hardware key 20 has been operated based on the information communicated by the hardware key receiving unit 52. Herein, when detecting that the hardware key 20 other than the hardware key 20 corresponding to the function of executing a software input mode, which is assigned a function, for example, the power ON/OFF function, or the camera shutter function or the like, has been operated, the analysis unit 60 directs the function processor 66 to perform the function corresponding to the hardware key 20. The function processor 66 performs the function corresponding to the hardware key 20 thus operated, in accordance with the direction from the analysis unit 60.

Herein, when detecting that the hardware key 20 corresponding to, the function of executing a software input mode has been operated, the analysis unit 60 directs the area setting unit 64 to set an area for displaying the software key 36 on the display screen 30. Upon receiving the direction from the analysis unit 60, the area setting unit 64 sets an area as the first software key display column 34a and the second software key display column 34b in FIG. 2. Specifically, the area setting unit 64 defines areas as many as the number of the pointing devices 10. The coordinates for the areas to be defined may be registered in advance, or set from outside.

Subsequently, the analysis unit 60 directs the software key display processor 62 to display the software key. As illustrated in FIG. 2, the software key display processor 62 displays a plurality of software keys 36 mapped to each of the character information included in the QWERTY arrangement. In this case, the software key display processor 62 displays the plurality of software keys 36 assigned to each of the first software key display column 34a and the second software key display column 34b, which are set by the area setting unit 64.

In this case, the software key display processor 62 displays the software keys 36 such that the character information mapped to each of the software keys 36 are not duplicative of each other in each of the software key display column 34, as illustrated in FIG. 2. Further, the software key display processor 62 displays the pointer 38 for every area. Subsequently, the software key display processor 62 communicates to the pointing display processor 58 that processing of displaying the software keys 36 and the pointers 38 has been completed, so that the operation in accordance with the content of the operation receivred by the software key receiving unit 50 is executed.

The software key receiving unit 50 includes a first software key receiving unit 50a through an N-th software key receiving unit 50c. N shows the number of the pointing devices 10. In the case of the mobile terminal device 100 illustrated in FIG. 1, N is 2. Herein, an operation directed to the first pointing device 10a is received by the first software key receiving unit 50a. An operation directed to the second pointing device 10b is received by the second software key receiving unit 50b, independently of the operation directed to the first pointing device 10a. An operation to be received is the information indicating a distance or a period of the pointing device 10 being traced, or that the device 10 has been pressed down.

The software key receiving unit 50 converts the contents of operation, each of which is independently received, into pointer information to communicate to the pointing display processor 58. The pointer information is a value that is obtained by converting a distance or a period of the pointing device 10 being traced into an amount of movement of the pointer 38, or a value indicating the period or the number of the pointing device 10 being pressed down, or the like. The algorithm for converting the content of operation into the pointer information can be performed by a known technique, and hence the description with respect thereto will be omitted herein.

Upon receiving, from the software key display processor 62, the communication saying that display of the software keys, etc., has been completed, the pointing display processor 58 maps the software key display column 34 set by the area setting unit 64 to the pointing device 10. Thereby, the pointing device 10 can operate only the software key 36 displayed in the software key display column 34 thus mapped via the software key receiving unit 50. Herein, the first pointing device 10a is mapped to the first software key display column 34a, and the second pointing device 10b to the second software key display column 34b. As stated above, a speed of a moving operation can be improved by limiting an operation range of the single pointing device 10. Further, a speed of an input operation can be improved by independently selecting the software key 36 displayed in each software key display column 34 with each of the plurality of pointing devices 10.

The pointing display processor 58 reflects the content of operation received by every software key receiving unit 50 in the corresponding software key display column 34. Specifically, the pointing display processor 58 converts the pointer information equivalent to an amount of movement of the pointer 38 thus communicated into a coordinate value, and directs the display unit 56 to move the pointer 38 displayed on the display screen 30 to the coordinate value. The display unit 56 performs the display processing in accordance with the direction from the pointing display processor 58.

When the information indicating that the pointing device 10 has been pressed down is communicated, the pointing display processor 58 compares the coordinate where the pointer 38 is located with the coordinate where the software key 36 is displayed. Herein, when the pointer 38 is located near the coordinate where the software key 36 is displayed, the pointing display processor 58 decides that the software key 36 has been selected. Further, the pointing display processor 58 directs the display unit 56 to display character information mapped to the software key 36 thus decided in the determined character display column 32 in FIG. 2.

According to the aforementioned embodiment, input operations can be performed efficiently by independently selecting each software key 36 displayed for every software key display column 34 with each of the plurality of pointing devices 10. Moreover, input operations can be performed efficiently by providing two pointing devices 10 to operate each of the devices 10 with each hand. Moreover, input operations can be performed more efficiently by assigning functions such as a conversion process, backspace processing and input of a space character, which have high frequencies of use, to the hardware keys. In this case, an operation range of the pointing device 10 can be limited by separating display objects for every area and by assigning functions to them, allowing input operations to be performed efficiently.

The aforementioned structures are implemented in the hardware by any CPU of a computer, memory, and other LSI, and implemented in the software by a computer program or the like that is loaded in a memory. Herein, functional blocks implemented by the cooperation of hardware and software are depicted. Therefore, it will be obvious to those skilled in the art that these functional blocks may be implemented in a variety of manners by hardware only, software only, or any combination thereof.

Subsequently, variations of the preferred embodiments of the present invention will be described. In the following variations, the same structures as the aforementioned embodiments will be denoted by the same reference numerals, and descriptions with respect thereto will be omitted for simplification of the description.

### (Variation of Structure of Mobile Terminal Device 100)

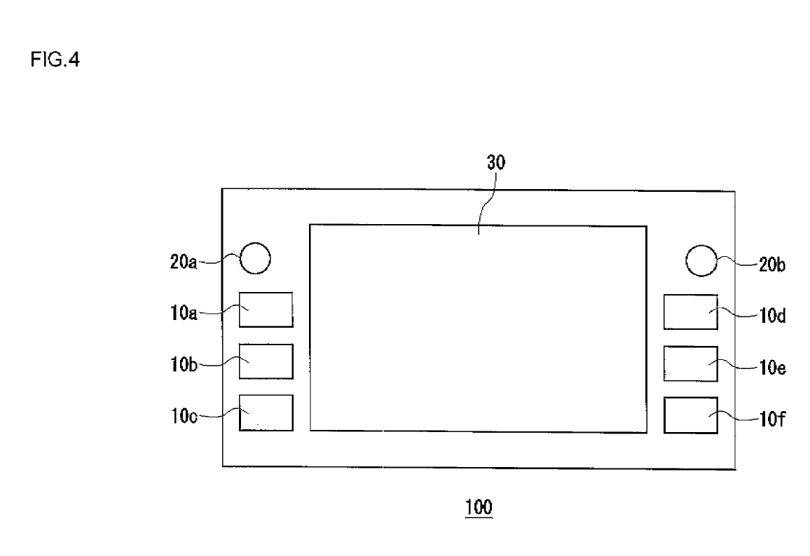

A variation of the structure of the mobile terminal device 100 in FIG. 1 will be at first illustrated. FIG. 4 is a view illustrating a first variation of the structure example of the mobile terminal device 100 in FIG. 1. The Mobile terminal device 100 according to FIG. 4 includes six pointing devices 10, two hardware keys 20 and a display screen 30. As illustrated herein, the number of the software keys 36 per area can be reduced by increasing the number of the pointing devices 10. Accordingly, an operation range of the pointing device 10 can be limited, and hence input operations can be performed more quickly. A display example on the display screen 30 preferred for the present variation will be described later.

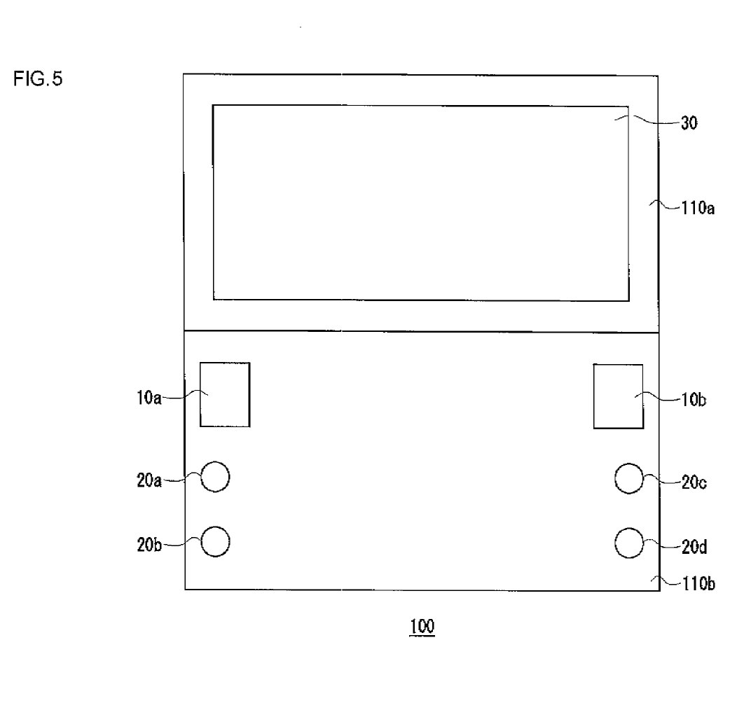

Subsequently, a second variation of the structure of the mobile terminal device 100 will be illustrated. FIG. 5 is a view illustrating the second variation of the structure example of the mobile terminal device 100 in FIG. 1. The mobile terminal device 100 according to FIG. 5 includes a first housing 110a and a second housing 110b. The first housing 110a and the second housing 110b may be structured so as to be folded on the boundary between the two, or structured such that the first housing 110a is slid to be housed, thereby the first housing 110a overlapping the second horsing 110b to form one body. Herein, the display screen 30 is arranged on the first housing 110a, and the pointing device 10 and the hardware key 20 are arranged on the second housing 110b. The display screen 30 can be made large by providing two housings to arrange each of the display screen 30 and the keys on each separate housing.

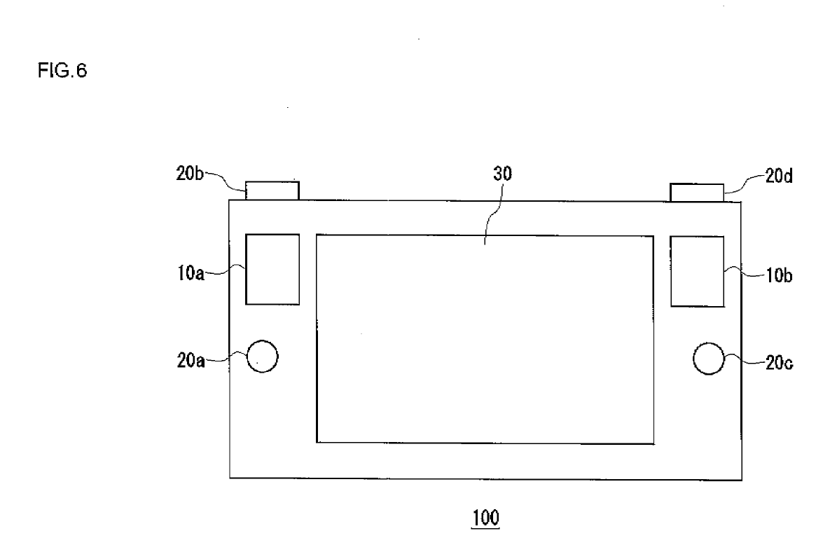

Subsequently, a third variation of the structure of the mobile terminal device 100 will be illustrated. FIG. 6 is a view illustrating the third variation of the structure example of the mobile terminal device 100 in FIG. 1. The mobile terminal device 100 according to FIG. 6 includes two pointing devices 10, four hardware keys 20 and a display screens 30. Herein, the first hardware key 20a and the third hardware key 20c are arranged on the same surface as the display screen 30. On the other hand, the second hardware key 20b and the fourth hardware key 20d are arranged on the surface perpendicular to the surface on which the first hardware key 20a and the third hardware key 20c are arranged.

With such an arrangement, the first hardware key 20a and the third hardware key 20c can be operated with a thumb. The second hardware key 20b and the fourth hardware key 20d can be operated with an index finger. Because these hardware keys can be operated independently with each of a thumb and an index finger, input operations can be performed easily, allowing an input speed to be improved. Moreover, a user can stably hold the mobile terminal device 100 by placing an index finger on the upper side of the mobile terminal device 100, thereby allowing input operations to be performed more easily.

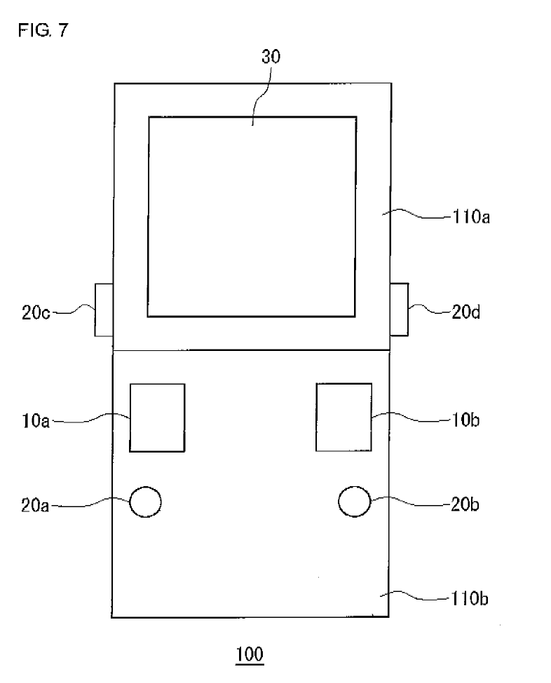

Subsequently, a fourth variation of the structure of the mobile terminal device 100 will be illustrated. FIG. 7 is a view illustrating the fourth variation of the structure example of the mobile terminal device 100 in FIG. 1. The mobile terminal device 100 according to FIG. 7 includes a first housing 110a and a second housing 110b. The display screen 30, the third hardware key 20c and the fourth hardware key 20d are arranged on the first housing 110a. Two pointing devices 10, the first hardware key 20a and the second hardware key 20b are arranged on the second housing 110b.

As illustrated in the drawing, the third hardware key 20c and the fourth hardware key 20d are arranged on the surface perpendicular to the surface on which the display screen 30 is arranged. Or, the two may be arranged at the edge of the surface on which the display screen 30 is arranged, instead of the surface perpendicular to the surface on which the display screen 30 is arranged. By arranging the hardware keys 20 as stated above, input operations can be performed easily, allowing an input speed to be improved. Moreover, input operations can be performed with one hand. Further, the display screen 30 can be made large by arranging the hardware keys 20 in a dispersed manner on each of the two housings 110.

### (Variation of Pointing Device 10)

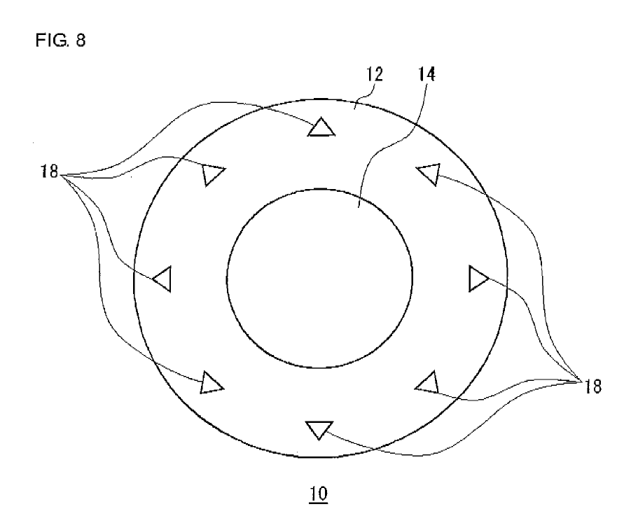

Subsequently, variations of the pointing device 10 in FIG. 1 will be illustrated. FIG. 8 is a view illustrating a first variation of the pointing device 10 in FIG. 1. The pointing device 10 according to FIG. 8 includes a direction key 12 and a determination key 14. By pressing down anyone of eight triangle arrows 18 illustrated in the drawing, the direction key 12 can move the pointer 38 in the direction of the arrow 18 being pressed down. By pressing down the determination key 14 in a state where the software key 36 displayed on the display screen 30 and the pointer 38 are overlapped one on another, the software key 36 is selected, and corresponding character information is displayed. As stated above, by assigning the functions regarding movement and determination of the pointer 38 to each of the separate keys, the movement and determination thereof can be easily distinguished from each other by the software key receiving unit 50 in FIG. 3, and hence the pointer 38 can be controlled easily.

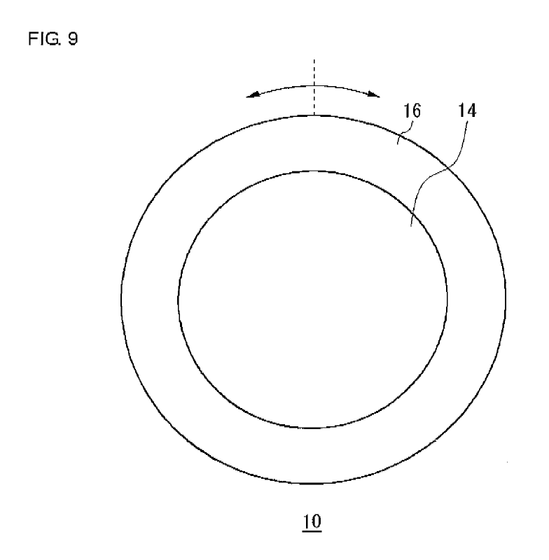

Subsequently, a second variation of the pointing device 10 will be illustrated. FIG. 9 is a view illustrating the second variation of the pointing device 10 in FIG. 1. The pointing device 10 according to FIG. 9 includes a determination key 14 and a rotation key 16. The rotation key 16 can move the pointer 38 displayed on the display screen 30 by rotated. The rotation key 16 is designed to be capable of being rotated in each direction of the clockwise and the counterclockwise rotations. Alternatively, the rotation key 16 may concurrently have a function of the direction key 12 illustrated in FIG. 8. In this case, the rotation key 16 can move the pointer 38 by rotated or pressed down in any one of the directions. By designing the pointing device 10 as stated above, an operation of moving the pointer 38 can be performed more easily, allowing an input environment comfortable for a user to be provided.

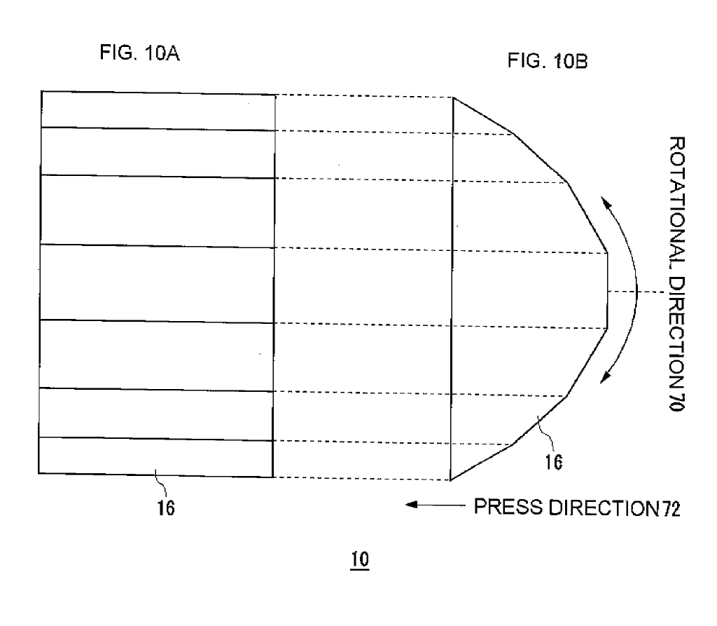

Subsequently, a third variation of the pointing device 10 will be illustrated. FIGS. 10A and 10D are views illustrating the third variation of the pointing device 10 in FIG. 1. FIG. 10A is a front view of the third variation of the pointing device 10 in FIG. 1. FIG. 10B is a side view of the third variation thereof. The pointing device 10 according to FIGS. 10A and 10B is a rotation key 16. The rotation key 16 can move the pointer 38 displayed on the display screen 30 by rotated in the rotational direction 70 illustrated in FIG. 10B with a finger. Also, the rotation key 16 performs determination processing by pressed dawn in the press direction 72 illustrated in FIG. 10B. By designing the pointing device 10 as stated above, an operation of moving the pointer 38 becomes easier, allowing an input environment comfortable for a user to be provided.

### (Variation of Display Example on Display Screen 30)

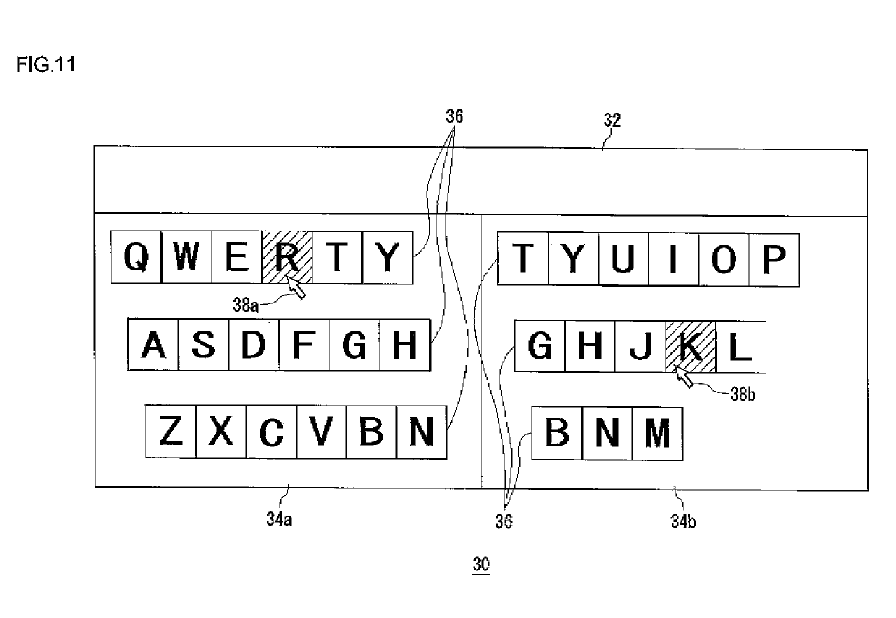

Subsequently, a variation of the display example on the display screen 30 in FIG. 2 will be illustrated. FIG. 11 is a view illustrating a first variation of the display example on the display screen 30 in FIG. 2. As illustrated, the software keys mapped to each of the character information of “Y”, “H”, “N”, “T”, “G” and “B” are duplicatively arranged in both the first software key display column 34a and the second software key display column 34b. By duplicatively arranged in this way, input operations can be performed with both pointing devices 10, allowing the degree of freedom for input operations to be improved.

Even for users who have mastered blind touch to the QWERTY arrangement, it is largely dependent on each user's typing way which hand operates “Y”, “U”, “N”, “T”, “G” and “B”, located near the middle of the QWERTY arrangement. Accordingly, as illustrated in FIG. 11, by duplicatively arranging the software keys 36 corresponding to each character information of “Y”, “H”, “N”, “T”, “G” and “B”, located near the middle of the QWERTY arrangement, in both software key display columns 24, an input environment independent of a user's typing way can be realized. In order to reduce an operating range of the pointing device 10 by further reducing the size of the area of the software key display column 34, the character information more likely to be affected by a user's typing way, for example, “Y”, “T” and “B”, may only be duplicatively arranged.

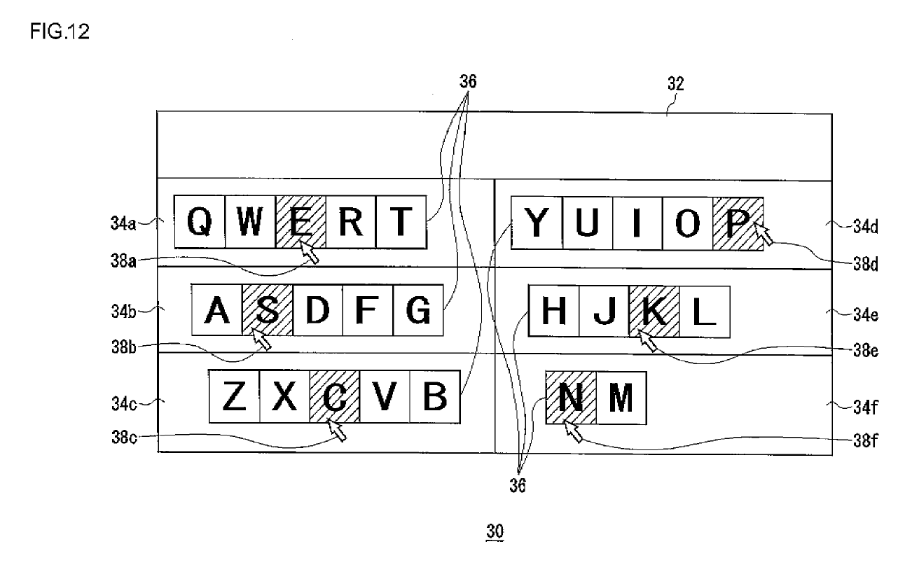

Subsequently, a second variation of the display example on the display screen 30 will be illustrated. FIG. 12 is a view illustrating the second variation of the display example on the display screen 30 in FIG. 2. As illustrated in the drawing, the software key display column 34 is divided into six areas by the area setting unit 64 in FIG. 3 In this variation, it is preferable that six pointing devices 10 are placed to be mapped to each area as illustrated in FIG. 4. The six areas are illustrated as the first software key display column 34a through the sixth software key display column 34f.

Each of the first software key display column 34a through the sixth software key display column 34f is mapped to each of the first pointing device 10a through the sixth pointing device 10f in FIG. 4. Further, either of the software keys 36 and the first pointer 38a through the sixth pointer 38f are displayed in the first software key display column 34a through the sixth software key display column 34f by the software key display processor 62 in FIG. 3. As illustrated in FIG. 12, each of six alphabet groups included in the QWERTY arrangement, the groups divided into three rows and two columns, is displayed in each of the software key display columns 34 similarly divided into three rows and two columns.

A moving range of the pointer 38 operated by the single pointing device 10 can be limited by setting areas as stated above, allowing input operations to be performed at a higher speed. Further, more intuitive input operations can be performed by dividing the alphabets based on the QWERTY arrangement into three rows and two columns to be arranged and by placing the pointing devices 10 so as to be mapped to each of the rows and columns.

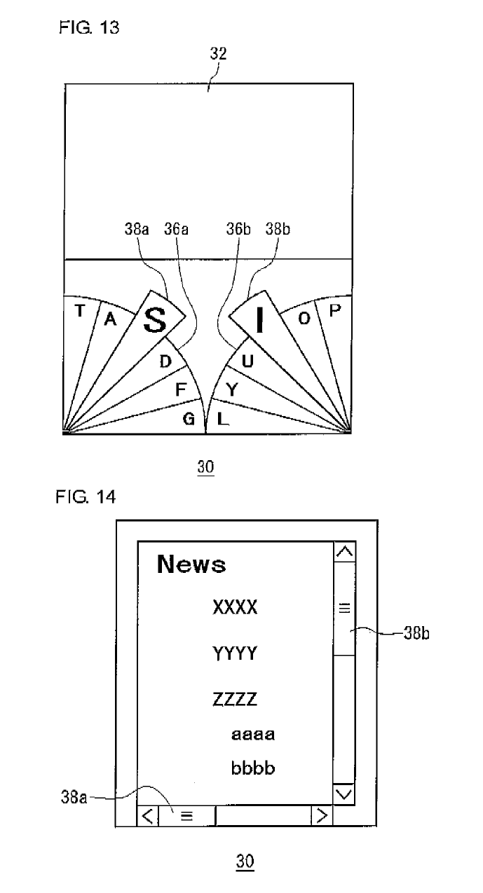

Subsequently, a third variation of the display example on the display screen 30 will be illustrated. FIG. 13 is a view illustrating the third variation of the display example on the display screen 30 in FIG. 2. As illustrated in the drawing, two quadrant-shaped software keys 36 are displayed in the software key display column 34 by the area setting unit 64 in FIG. 3. In this variation, it is preferable that two rotation keys 16 illustrated in FIGS. 9 and 10 are placed. By rotating the rotation key 16, the corresponding software key 36 is rotated, resulting in the display of the character information to be displayed as the software key 36. Herein, the pointer 38 in this variation is always located at a constant position. The software key 36 overlapping the pointer 38 is displayed in an emphasized manner as illustrated. By displaying the software key 36 in this way, the rotation key 16 illustrated in FIGS. 9 and 10 can be used more effectively.

Subsequently, a fourth variation of the display example on the display screen 30 will be illustrated. FIG. 14 is a view illustrating the fourth variation of the display example on the display screen 30 in FIG. 2. As illustrated in the drawing, two scroll bars are displayed on the display screen 30 according to FIG. 14. In FIG. 14, the two scroll bars are displayed as the first pointer 38a and the second pointer 38b. The first pointer 38a and the second pointer 38b can be moved by operating each of the corresponding pointing devices 10, which scrolls the screen in accordance with the movement. With such an embodiment, the screen can be scrolled simultaneously in the horizontal direction and the vertical direction, and hence even an Internet website for which a relatively large area is needed, such as newspaper, or a PDF (Portable Document Format) having a large page area, can be browsed comfortably.

The present invention has been described based on the preferred embodiments. The aforementioned embodiments are intended to be illustrative only. It will be appreciated by those skilled in the art that various modifications to combinations of the constituting elements and processes could be developed and that such modifications are within the scope of the present invention.

In the preferred embodiments and variations thereof according to the present invention, it has been described that the character strings based on the QWERTY arrangement are mapped to the software keys 36 and displayed. However, without limiting thereto, the character strings based on, for example, the QWERTZ arrangements used in the German-speaking world and the Czech-speaking world, and the AZERTY (ASERTY) arrangement used in the French-speaking world, or the JIS arrangement including kana characters, may be mapped to the software keys 36.

Alternatively, the display screen 30 of the mobile terminal device 100 may be divided into a plurality of areas by the area setting unit 64, and character arrangement may be classified and displayed in each of the plurality of areas by the software key display processor 62, so that the classified character arrangements can be easily typed. Further, the mobile terminal device 100 may be configured that the classification of the character arrangements is designated by a user, or that a typing tendency learning unit provided in the mobile terminal device 100 learns a user's typing way to classify the character arrangement into each area, so that the software keys are displayed. With such an embodiment, a more comfortable input environment can be provided to a user. Further, it is needless to say that the same effects as the aforementioned embodiments can be obtained.

### INDUSTRIAL APPLICABILITY

According to the present invention, an efficient input operating environment can be realized.

1. A mobile terminal device comprising:
an area setting unit configured to set a plurality of display areas for displaying a plurality of software keys mapped to each of a plurality of pieces of character information included in a predetermined input character type;
a software key display unit configured to display two or more software keys assigned to each of the plurality of display areas set by the area setting unit, in corresponding display areas;
a plurality of pointing devices configured to be able to select the software keys displayed by the software key display unit, independently for every display area; and
a character information display unit configured to display character information corresponding to the software key selected by the pointing device.

2. The mobile terminal device according to claim 1, wherein the plurality of pointing devices include a left-hand pointing device and a right-hand pointing device, which are arranged to be a right-and-left pair in front of the screen of the mobile terminal device.

3. The mobile terminal device according to claim 1, wherein each of the plurality of display areas set by the area setting unit is mapped to each of the plurality of pointing devices, and wherein the pointing device selects the software key specified for every display area by moving a pointer displayed in the display area thus mapped.

4. The mobile terminal device according to claim 1, wherein all character information included in the predetermined input character type are mapped to any one of the plurality of software keys displayed by the software key display unit.

5. The mobile terminal device according to claim 1, wherein any one of the plurality of pieces of character information included in the predetermined input character type, is duplicatively mapped to a plurality of software keys so as to be displayed in two or more display areas.

6. The mobile terminal device according to claim 1, wherein the predetermined character type is alphabets, and wherein the plurality of pointing devices include a left-hand pointing device and a right-hand pointing device, and wherein the area setting unit sets two display area, each of which is mapped to each of the left-hand and the right-hand pointing devices, and wherein the software key display unit displays, among the QWERTY arrangement representing the alphabet order, at least the software keys corresponding to each of the character information of “Q”, “W”, “E”, “R”, “A”, “S”, “D”, “F”, “Z”, “X”, “C” and “V”, in the display area corresponding to the left-hand pointing device; on the other hand, displays, among the QWERTY arrangement, at least the software keys corresponding to each of the character information of “U” “I”, “O”, “P”, “J”, “K”, “L” and “M”, in the display area corresponding to the right-hand pointing device.

7. The mobile terminal device according to claim 6, wherein the software key display unit duplicatively displays, among a plurality of pieces of character information included in the QWERTY arrangement, at least the software keys corresponding to each of the character information of “Y”, “T” and “B”, in both display areas corresponding to each of the left-hand pointing device and the right-hand pointing device.

8. The mobile terminal device according to claim 1, further comprising a hardware key having a function of inputting any one of a conversion process, backspace processing and a space character.

9. The mobile terminal device according to claim 8, wherein the hardware key is arranged so as to be operated with a finger different from that operating the software key.

10. An input device comprising:
a software key display unit configured to display a plurality of software keys, each of which is mapped to character information included in a predetermined input character type, in each of two display areas in accordance with a character arrangement;
two pointing devices configured to select each of the software keys displayed by the software key display unit, independently for every display area; and
a character information display unit configured to display the character information corresponding to the software key selected by the pointing device.
